(19) United States
(12) Patent Application Publication
(10) Pub. No.: US 2025/0062062 A1
(43) Pub. Date: Feb. 20, 2025

(54) MAGNETIC COMPONENT INTEGRATION

(71) Applicant: UNIVERSITY COLLEGE CORK, NATIONAL UNIVERSITY OF IRELAND, CORK, Cork (IE)

(72) Inventors: Zoran PAVLOVIC, Cork (IE); Seamus O'DRISCOLL, Cork (IE)

(21) Appl. No.: 18/723,779

(22) PCT Filed: Dec. 22, 2022
(86) PCT No.: PCT/EP2022/087537

§ 371 Date: Jun. 24, 2024

(30) Foreign Application Priority Data
Dec. 24, 2021 (GB) 2119005.3

(51) Int. Cl. H01F 17/00; H01F 41/04

(52) U.S. Cl. CPC H01F 17/0013; H01F 41/046; H01F 2017/002; H01F 2017/0066

(57) ABSTRACT

A device (90) is disclosed, comprising: a first upper conducting layer (101) and second upper conducting layer (102); a first lower conducting layer (111) and second lower conducting layer (112); a core layer (131) between the first and second upper conducting layers (101, 102) and the first and second lower conducting layers (111, 112); a first via (121) connecting the first upper conducting layer (101) to the first lower conducting layer (111); a second via (122) connecting the second upper conducting layer (102) to the second lower conducting layer (112). The first via (121) and the second via (122) are concentric.

### FIELD OF INVENTION

The present invention relates to magnetic components, their integration with printed circuit boards, and related methods.

### BACKGROUND

Miniaturised power electronics are a key component in enabling high performance and miniaturised electronics. Printed circuit boards with embedded magnetic materials (i.e. with a high magnetic permeability) have been proposed in order to improve miniaturisation and reliability of magnetic devices (e.g. transformers, inductors) 1.

Inductor and transformer devices with magnetic material cores are in widespread use in electrical power converters, filters, and galvanic isolators.

Printed circuit boards with embedded magnetic core material are promising for providing high density and high performance inductors. Further improvements in this technology are desirable.

### SUMMARY

According to a first aspect of the invention, there is provided a device, comprising:
an upper conducting layer;
a lower conducting layer;
a magnetic core layer between the upper conducting layer and the lower conducting layer;
a through core via defining a conducting path through the magnetic core material layer and connecting the upper conducting layer to the lower conducting layer.

The term “conducting” means electrically conducting.

The through core via may be at least partially surrounded by the magnetic core layer.

The upper conducting layer may be a patterned upper conducting layer, and the lower conducting layer may be a patterned lower conducting layer. The patterned upper conducting layer, patterned lower conducting layer and the through core via may together define an inductor winding around an inductor core, the inductor core comprising at least a region of the magnetic core layer.

The inductor winding may comprise a plurality of turns around the inductor core, with a first portion of each of the plurality turns of defined by the patterned upper conducting layer and a second portion of each of the plurality of turns defined by the patterned lower conducting layer.

The patterned upper conducting layer may be one of a plurality of patterned upper conducting layers on an upper side of the magnetic core layer. Each of the plurality of upper conducting layers may define at least a part of the inductor winding. The patterned lower conducting layer may be one of a plurality of patterned lower conducting layers on a lower side of the magnetic core layer. Each of the plurality of lower conducting layers may define at least a part of the inductor winding.

A patterned upper conducting layer and a corresponding patterned lower conducting layer may define a winding layer.

Each of the patterned upper conducting layers may be connected to a corresponding patterned lower conducting layer by a through core via that defines a conducting path through the magnetic core material layer.

The upper conducting layer may be a first upper conducting layer and the device may comprise a second upper conducting layer. The lower conducting layer may be a first lower conducting layer, and the device may comprise a second lower conducting layer. The through core via may be a first through core via, connecting the first upper conducting layer to the first lower conducting layer. The device may comprise a second through core via, concentric with the first through core via. The second through core via may connect the second upper conducting layer to the second lower conducting layer.

The first through core via may surround the second through core via.

The device may comprise more than two upper conducting layers, and more than two lower conducting layers, each of the more than two upper conducting layers and the more than two lower conducting layers forming the inductor winding.

Through core vias may connect corresponding upper and lower patterned conducting layers.

The (or at least one, or each) through core via may be in contact with the magnetic core layer. The through core via may be in contact with a conformal insulating layer (i.e. that is conformally coated) configured to provide insulation between the through core via and the magnetic core layer. The conformal insulating layer may comprise polypyyrole, or a similar insulating material that can be electrodeposited, for example.

The through core via may be in contact with the magnetic core, even where the magnetic core is a conducting material (e.g. with a resistivity less than 0.1 ohm·mm). In such embodiments an isolation gap may be defined between the magnetic core and any other conductors of the device.

The magnetic core layer may be one of a plurality of magnetic core layers between the upper conducting layer and the lower conducting layer.

The device may further comprise an upper magnetic layer and a lower magnetic layer, wherein the upper conducting layer is disposed between the upper magnetic layer and the magnetic core layer, and the lower conducting layer is disposed between the lower magnetic layer and the magnetic core layer.

The inductor core may comprise at least a region of the plurality of magnetic core layers.

The magnetic core layer may be an electrical insulator (or may be a poor electrical conductor for example with an electrical resistivity of 0.1 ohm·mm or more, or 0.01 ohm·m or more). The magnetic core layer may comprise a sputter deposited material. For example, the magnetic core layer may comprise a sputtered Co—Zr—Ta—B material. The magnetic core layer may comprise a Co—Zr—Ta—B composite, in which the Co—Zr—Ta—B is co-sputtered with an insulating phase. The insulating phase may comprise a silicon oxide.

The thickness of the sputter coated magnetic core layer may be less than 50 microns, less than 20 microns, or less than 10 microns.

The magnetic core layer may comprise a non-metal (e.g. polymer) matrix with embedded metal particles. The particles may be any shape and size distribution—for example, spherical, flakes, rods, monodisperse, polydisperse.

The device may be a printed circuit board. The device may be a power converter (e.g. comprising a printed circuit board). The device may comprise a silicon substrate or a ceramic substrate.

The upper conductive layer, lower conductive layer and the through core via may comprise or consist of the same material.

The printed circuit board may comprise fibre-reinforced polymer composite layers.

The first and second conducting layers may comprise copper.

The layers (first and second conducting layers, magnetic core etc) may be disposed in offset parallel planes

According to a second aspect, there is provided a method of processing a printed circuit board, the printed circuit board comprising a conducting upper layer and a conducting lower layer, and a magnetic core layer between the conducting upper layer and the conducting lower layer.

The method comprises:
forming a through core hole in the magnetic core layer of the printed circuit board;
connecting the upper conducting layer to the lower conducting layer by at least partially filling the through core hole with a conductor.

At least partially filling the through core hole may comprise electroplating a metal into the through core hole.

The method may comprise conformally coating an insulating material on an interior surface of the through core hole prior to at least partially filling the through core hole with a conductor. Conformally coating an insulating material on an interior surface of the through core hole may comprise electrodepositing the insulating material or vapour phase depositing the insulating material. The thickness of the insulating layer may be less than or equal to the thickness of either of the first conducting layer or the second conducting layer.

The method may further comprise patterning the upper conducting layer and/or the lower conducting layer.

Patterning the upper conducting layer or the lower conducting layer may comprise patterning a resist layer and etching a pattern defined by the resist layer in the upper or lower conducting layer.

The patterning may comprise forming an inductor from the conducting upper layer and the conducting lower layer.

The method may comprise forming a device according to the first aspect, including any optional features thereof.

According to a third aspect, there is provided a device comprising:
a first upper conducting layer and second upper conducting layer;
a first lower conducting layer and second lower conducting layer;
a core layer between the first and second upper conducting layers and the first and second lower conducting layers;
a first via connecting the first upper conducting layer to the first lower conducting layer;
a second via connecting the second upper conducting layer to the second lower conducting layer;
wherein the first via and the second via are concentric.

The core layer may be a magnetic core layer (but this is not essential to the third aspect).

The first via and the second via may comprise part of an inductor winding. The inductor winding may be configured such that current flowing in the inductor flows in the same direction through the first via and the second via. The inductor winding may comprise a plurality of pairs of concentric vias, each pair of concentric vias comprising a first via and a second via. When a current flows in the inductor, the current flow in the first via and second via in each pair may be in the same direction (different pairs of vias may have current flow in different directions).

At least one of the first upper conducting layer, second upper conducting layer, first lower conducting layer and second lower conducting layer may be patterned to form an inductor winding around an inductor core. In some embodiments the inductor core may comprise at least a region of the magnetic core layer (but this is also not essential).

The first via and the second via may be through core vias that are at least partially surrounded by the magnetic core layer.

The device may comprise more than two patterned upper conducting layers, and more than two patterned lower conducting layers, each of the more than two patterned upper conducting layers and the more than two patterned lower conducting layers forming the inductor winding.

According to a fourth aspect, there is provided a method of making a device according to the third aspect. The method may comprise:

forming a first through hole through the core layer:
depositing a conducting material in the first through hole to form the first via; forming a second through hole through the first via;
depositing an insulating material on an interior sidewall of the second through hole;
depositing a conducting material in the second through hole to form the second via.

According to a fifth aspect, there is provided a method of using the device according to the first or third aspect as at least part of an inductor, transformer or power converter.

Features of the device of the first aspect may be combined with features of the device of the third aspect, including optional features. Features of the device of the third aspect may be combined with features of the first aspect, including optional features. The method of the second aspect may be used to form a device according to the third aspect. Method steps from the fourth aspect may be used in the method of the second aspect,

### BRIEF DESCRIPTION OF THE DRAWINGS

FIG. 1 is a schematic cross section of an device according to an embodiment;

FIG. 2 shows example steps of a process for making a device according to an embodiment;

FIGS. 3 and 4 compare an inductor in accordance with an embodiment (FIG. 3) with an inductor according to an embodiment (FIG. 4);

FIG. 4a shows an embodiment with an striped inductor;

FIG. 5 shows a cross section of a further device according to an embodiment;

FIG. 6 shows a cross section of a still further device according to an embodiment;

FIG. 7 shows a cross section of a device according to an embodiment comprising additional magnetic layers;

FIG. 8 shows a cross section of a device with several conducting layers, core layers and pre-preg layers;

FIGS. 9 and 10 shows a magnetic field simulation of an inductor according to an embodiment, with FIG. 9 showing a plan view and FIG. 10 showing a cross section;

FIG. 11 shows a schematic cross sectional diagram of a device according to an embodiment with concentric vias;

FIGS. 12 to 14 show an example inductor comprising through core vias that are concentric:

FIGS. 15 to 17 show a further example inductor comprising through core vias that are concentric; and

FIG. 18 shows a schematic cross section of a metal composite magnetic material suitable for use as a magnetic core layer in certain embodiments.

### DETAILED DESCRIPTION

Reference to “upper” and “lower” in this specification should be understood as relative terms, not implying a specific orientation of a device. Figures may have an exaggerated thickness scale, in order to more clearly illustrate features of the invention. Figures are not necessarily to scale. In each of the embodiments, conducting layers may be patterned to define conducting tracks (e.g. to form an inductor winding).

FIG. 1 is a schematic cross section of a device 100 according to an embodiment, comprising upper conducting layer 101, lower conducting layer 111 and magnetic core layer 131. The upper conducting layer 101 is electrically connected to the lower conducting layer 111 by a through core via 121.

The layers of the device 100 may be arranged in parallel planes, offset from each other in the direction normal to the planes. Devices 100 in accordance with embodiments (of any aspect) may comprise a printed circuit board (rigid or flexible), a package or interposer comprising at least one ceramic layer, or a silicon substrate. The conducting layers (upper and lower) may comprise a metal conductor (e.g. copper), and the through core via 121 may comprise the same material as the conducting layers 101, 111.

In an embodiment, the device 100 may comprise a printed circuit board. Multi-layer printed circuit boards may comprise one or more core layers and one or more pre-preg layers. The core layers are pre-cured, and the pre-preg layers are not fully cured. Pre-preg layers may be combined with the core layers and the resulting stack cured to bond the stack together (with the pre-preg layers bonding to any adjacent core layers). Each of the pre-preg and core layers may comprise fibre reinforced composite (complying with FR4 or similar).

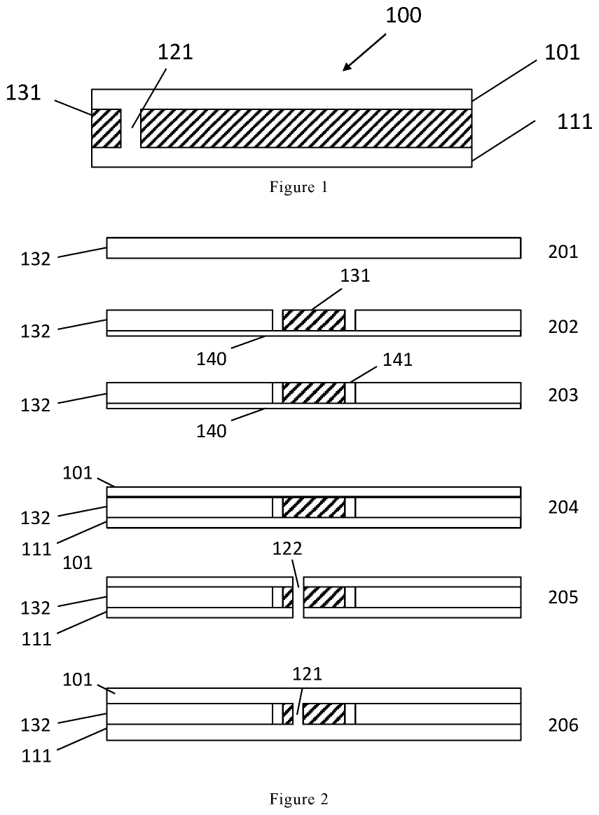

FIG. 2 shows an example steps of a process for making a device according to an embodiment. Step 201 starts with a PCB core layer 132. In step 201, a cavity is formed in the core layer 132, for example using a router or laser machining tool. At step 202, magnetic core layer 131 is disposed in the cavity. A releasable layer 140 may be provided under the magnetic core layer 131 to support the magnetic core layer 131. At step 203, an adhesive fill 141 may be placed in the cavity to bond the magnetic core layer 131 to the core layer 132 (and optionally, planarize the layer). At step 204, a lower conductive layer 111 (e.g. comprising copper) may be deposited on the lower side of the core layer 132 and an upper conductive layer 101 may be deposited on the upper side of the core layer 132. In some embodiments, a pre-preg layer may be interposed between the lower conductive layer 111 (or upper conductive core layer 101) and the core layer 132, or a pre-preg layer may be disposed on the lower side of the lower conductive layer 111 (or the upper conductive layer 101).

At step 205 a hole 122 is formed through the upper and lower conducting layers 101, 111 and the magnetic core layer 131, for example by drilling (e.g. using mechanical or laser drilling).

At step 206, a metal layer is deposited to form a through core via 121 that connects the upper conducting layer 101 to the lower conducting layer 111 through the magnetic core layer. The additional metal may increase the thickness of the upper and lower conducting layers, and may be electrodeposited. The through core via 121 may be entirely surrounded by the magnetic core layer 131, or only partially surrounded by the magnetic core layer 131.

Embodiments may provide enhanced flux coupling to the magnetic core layer 131 resulting from currents carried by the upper and lower conducting layers 101, 111. The closer that the current carrying conductors are to the magnetic core material, the better the coupling of flux to the magnetic core material. Embodiments of the invention therefore enable higher performance and/or more compact passive components, such as inductors, to be formed. Such devices may be integrated with printed circuit boards or other devices comprising magnetic core layers.

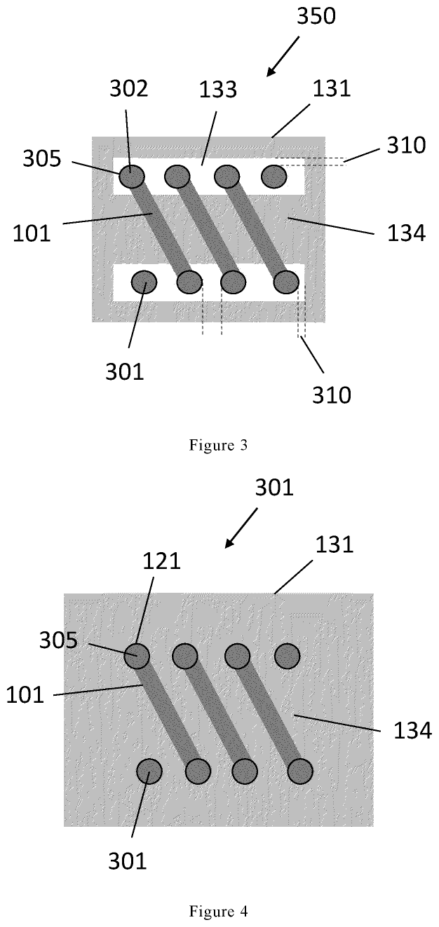

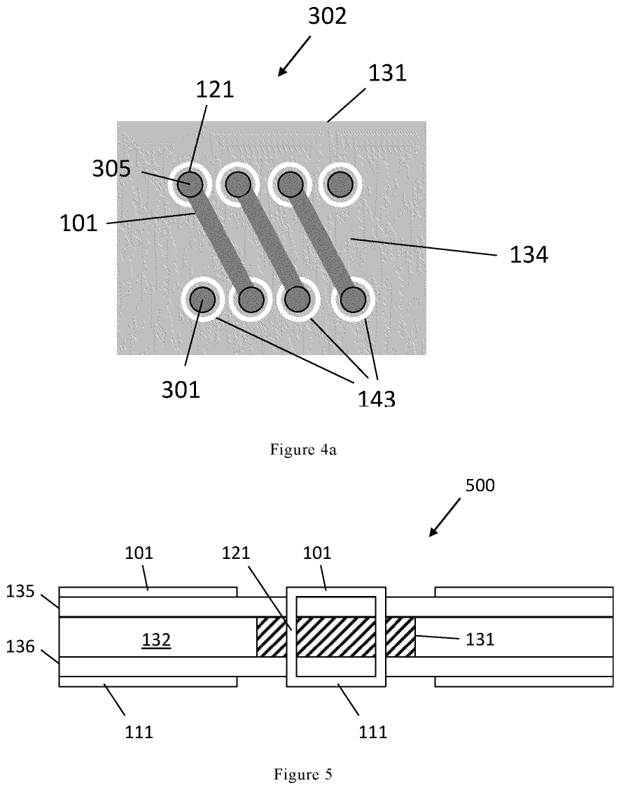

FIGS. 3 and 4 compare an inductor 350 not in accordance with an embodiment (FIG. 3) with an inductor 301 according to an embodiment (FIG. 4). FIG. 3 shows a top view of the inductor 350, and shows layers corresponding with a pattern of the upper conducting layer 101 and the magnetic core layer 131. The magnetic core layer 131 is patterned to include window regions 133 for accommodating vias connecting the upper conducting layer 101 to a lower conducting layer (not shown) on the other side of the magnetic core layer 131. The upper conducting layer 101 and lower conducting layer are connected by vias to define an inductor winding about a central portion 134 of the magnetic core layer 131. For example, starting at position 301 in the upper conducting layer 101, a conducting via is provided to the lower conducting layer, and a conducting trace defined in the lower conducting layer provides a connection to point 302, where a further conducting via connects the lower conducting layer to the upper conducting layer. This example (not in accordance with the invention) represents the case where a design rule is implemented that requires a (non-zero) minimum spacing 310 (e.g. at least 100 microns or at least 200 microns) between conducting vias connecting the upper and lower conducting layers and the magnetic core material.

FIG. 4 shows an inductor 301 according to an embodiment, in which there is no design rule requirement for there to be a minimum spacing between the pattern defining the vias 121 that connects the upper conducting layer 121 to the lower conducting layer. The vias 121 are through core vias patterned through (i.e. intersecting) the magnetic core layer 131, without first opening a window 133 in the magnetic core layer 131. The vias 121 are formed by patterning a hole directly through the magnetic core layer 131 and then filling the hole with a conducting material (e.g. by electroplating). The lack of spacing between the through core vias 121 and the magnetic core material 131 enhances magnetic flux coupling to the inductor core 134. This may enable a more compact inductor and/or an inductor with higher performance.

The conducting material of the through core via 121 may be in contact with the magnetic core layer 131. For example, the magnetic core layer 131 may be an electrical insulator, or have a very low electrical conductivity. Suitable magnetic core materials may comprise polymers loaded with metal (e.g. ferrite) particles or flakes, or polymeric magnetic materials.

In other embodiments, the hole patterned for the through core via 121 may first be coated with a layer of insulating material before a conducting layer is deposited to form the through core via 121. The insulating material may, for example, be electrodeposited (e.g. polypyrrole or another electrodepositable polymeric material), or vapour deposited (e.g. parylene or another material suitable for conformal vapour deposition). The thickness of the insulating material between the through core via 121 and the magnetic core layer 131 may be less than 50 microns, 20 microns, 10 microns, 5 microns, or less than 2 microns. A typical design rule spacing in PCB design is ˜250 microns or more.

In some embodiments, a conducting magnetic core material may be used, and the through core vias 121 may be in contact with the conducting magnetic material of the magnetic core layer 131. FIG. 4a shows a variation on the example of FIG. 4 in which the magnetic core layer 131 is be patterned with isolating gaps 143 to prevent the magnetic core layer 131 short circuiting parts of the inductor. For example, the magnetic core material 131 may comprise a sputtered magnetic material, and the isolating gap(s) may be patterned by an etch.

A similar technique may be used to isolate regions of the magnetic core layer from any other conductors that should not be in contact with the magnetic core layer.

FIG. 5 shows a further device 500 according to an embodiment, comprising: core layer 132, magnetic core layer 131, upper pre-preg layer 135, upper conducting layer 101, lower pre-preg layer 136, lower conducting layer 111 and through core vias 121.

This embodiment is similar to those already described, except that there are pre-preg layers 135, 136 separating the upper conducting layer 101 and lower conducting layer 111 from the core layer 132 and the magnetic core layer 131. The upper conducting layer 101, lower conducting layer 111 may be patterned to define windings of an inductor (together with the through core vias 121). The inductor may be wound about a region of the magnetic core layer 131. Efficient magnetic flux coupling with the magnetic core layer 131 may be achieved as a result of the lack of spacing between the through core vias 121 and the magnetic core layer 131.

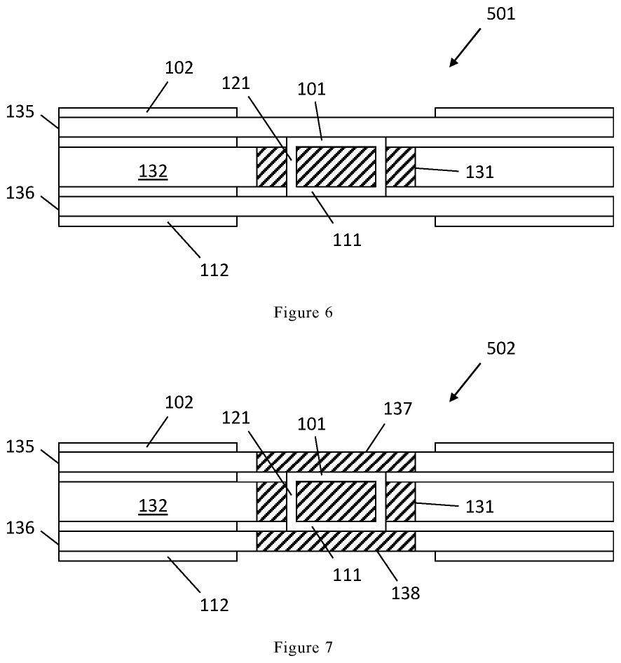

FIG. 6 shows a further device 501 according to an embodiment, comprising: core layer 132, magnetic core layer 131, upper pre-preg layer 135, first and second upper conducting layers 101, 102, lower pre-preg layer 136, first and second lower conducting layers 111, 112, and through core vias 121.

This embodiment is similar to the device of FIG. 5, except that the upper pre-preg layer 135 separates the first upper conducting layer 101 from the second upper conducting layer 102, and the lower pre-preg layer 136 separates the first lower conducting layer 111 from the second lower conducting layer 112. The first upper conducting layer 101 and first lower conducting layer 111 are in contact with the magnetic core layer 131.

FIG. 7 shows a variation on the embodiment of FIG. 6, in which a portion of the pre-preg layers 135, 136 on either side of the magnetic core layer has been replaced with further magnetic material, providing an upper magnetic layer 137 and lower magnetic layer 138. The first conducting layer 101 is disposed between the upper magnetic layer 137 and the magnetic core layer 131, and the second conducting layer 111 is disposed between the lower magnetic layer 138 and the magnetic core layer 131.

In embodiments the upper magnetic layer 137 may be disposed between pre-preg layer 135 and the upper conducting layer 101 (rather than disposed in a cavity defined in the pre-preg layer 135. Similarly, the lower magnetic layer 138 may be disposed between pre-preg layer 136 and the lower conducting layer 111 (rather than disposed in a cavity defined in the pre-preg layer 138).

The inclusion of the upper and lower magnetic layers 137, 138 enhances the inductance of an inductor defined by the first upper conducting layer 101, first lower conducting layer 111 and the through core vias 121, by providing a material with high permeability in contact with the conductors defining the inductor. As already discussed, direct contact between the magnetic material and the conducting layers is possible where the magnetic material is non-conducting. A thin insulating layer (e.g. 20 microns or less, or microns or less, as already described with reference to the vias) may be used to isolate a magnetic material from the conducting layer (while still providing efficient flux coupling)

Other variations are possible—for example, different layer stacks of pre-preg and conducting foils are possible. Further core layers may also be employed.

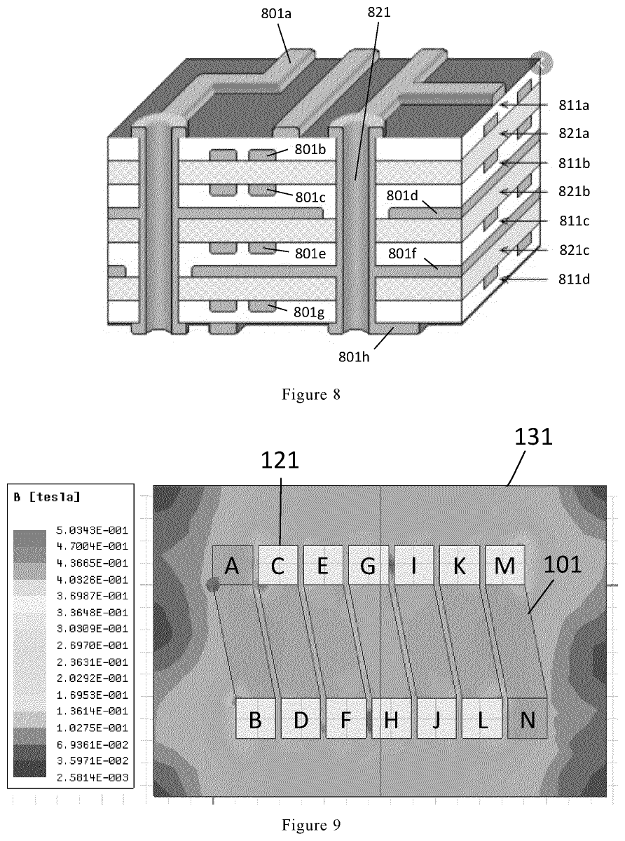

FIG. 8 illustrates a layer construction for a printed circuit board comprising a plurality of conducting layers 801a-h, a plurality of pre-preg layers 811a-d, a plurality of core layers 821a-c and a through core via 821. At least one of the core layers 821a-c is a magnetic core layer (e.g. one of them, two of them or all of them may be magnetic core layers). Any of the conducting layers 801a-h may be patterned (or may form a ground plane or EMI screen). The through core vias 821 may connect any of the conducting layers 801a-h to any other of the conducting layers 801a-h, depending on how the conducting layers 801a-h are patterned.

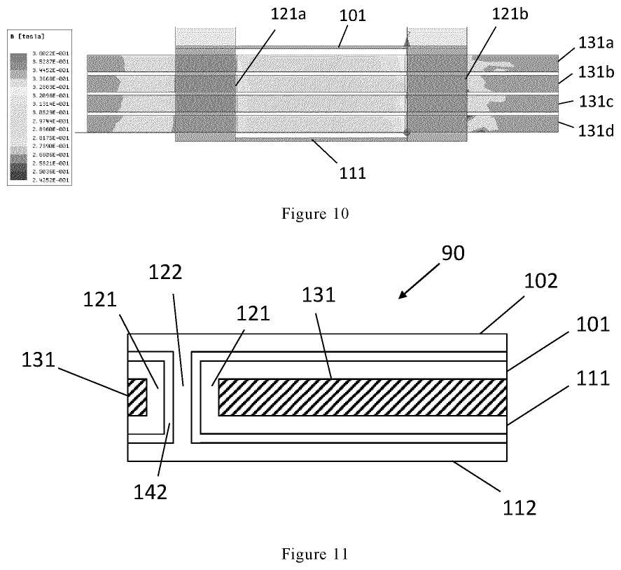

FIGS. 9 and 10 show a simulation of an inductor according to an example embodiment. Current flows in the direction from A to B and so on (ABCDEFGHIJKLMN), with the upper conducting layer 101 connecting A to B (and C to D etc) and the lower conductor layer connecting B to C (D to E etc). Through core vias 121 connect the upper conducting layer 101 to the lower conducting layer 111 at each of BCDEFGHIJLKM. In this example there are four magnetic core layers 131a-d, each separated by a pre-preg layer (not shown). Further pre-preg layers (not shown) are interposed between the upper conducting layer 101 and the magnetic core layer 131a and the lower conducting layer 111 and the magnetic core layer 131d. FIGS. 9 and 10 show the distribution of magnetic field. This example enables 1.7 times more power density than a design produced using design rules that enforce a minimum spacing (e.g. ˜250 microns) between vias (connecting the upper conducting layer with the lower conducting layer) and the magnetic core layers 131a-d.

In certain embodiments, the type of multilayer construction discussed with reference to FIG. 8 may be used to construct an inductor with multiple conducting layers on either side of a magnetic core layer. For example, the turns shown in FIGS. 9 and 10 may be repeated in concentric winding layers. The type of example shown in FIGS. 9 and 10 may also be made according to the examples of FIGS. 5 to 7.

In the approach of FIG. 8, the through core via 821 connects any conducting layers that are patterned to overlap with the through core via 821. This means that a through core via that is intended to only connect layers 801b to 801c must have a minimum design rule spacing around it in on all other layers. When constructing multi-layer devices (for example multi-layer inductors), this requirement for minimum spacing between different vias can lead to a less compact design (which may result in reduced power density).

FIG. 11 shows a device 90 according to an example embodiment in which concentric vias 121, 122 are employed, which may solve at least some of these problems. The device 90 comprises: magnetic core layer 131, first upper conducting layer 101, second upper conducting layer 102, first lower conducting layer 111, second lower conducting layer 112, and insulating layer 142.

The first upper conducting layer 101 is disposed on an upper side of the magnetic core layer 131 (and may be, but does not have to be, in direct contact therewith). The first lower conducting layer 111 is disposed on lower side of the magnetic core layer 131 (and may be, but does not have to be, in direct contact therewith). The first upper conducting layer 101 and the first lower conducting layer 111 are connected by a first through core via 121. The second upper conducting layer 102 is disposed on an upper side of the first upper conducting layer 101, and the second lower conducting layer 112 is disposed on a lower side of the first lower conducting layer 111. An insulating layer 142 separates the first upper conducting layer 101 from the second upper conducting layer 102, and a similar insulating layer 142 separates the first lower conducting layer 111 from the second lower conducting layer 112. A second through core via 122 connects the second upper conducting layer 102 to the second lower conducting layer 112. The first through core via 121 is concentric with the second through core via 122. In this example the first through core via 121 is an outer via, with the second through core via 122 surrounded by the first through core via 121. The first through core via 121 is not spaced apart from the magnetic core layer (i.e. there is no design rule requiring spacing between the patterns defining the first through core via 121 and the magnetic core 131). The insulating layer 142 may, for example, be electrodeposited (e.g. polypyrrole or another electrodepositable polymeric material), or vapour deposited (e.g. parylene or another material suitable for conformal vapour deposition).

This concentric via arrangement may advantageously reduce the footprint of a device. An inductor comprising concentric through hole vias 121, 122 may have higher inductance for a given footprint, and/or higher power density. This concentric via arrangement may also be applicable more widely, to devices that do not comprise a magnetic layer.

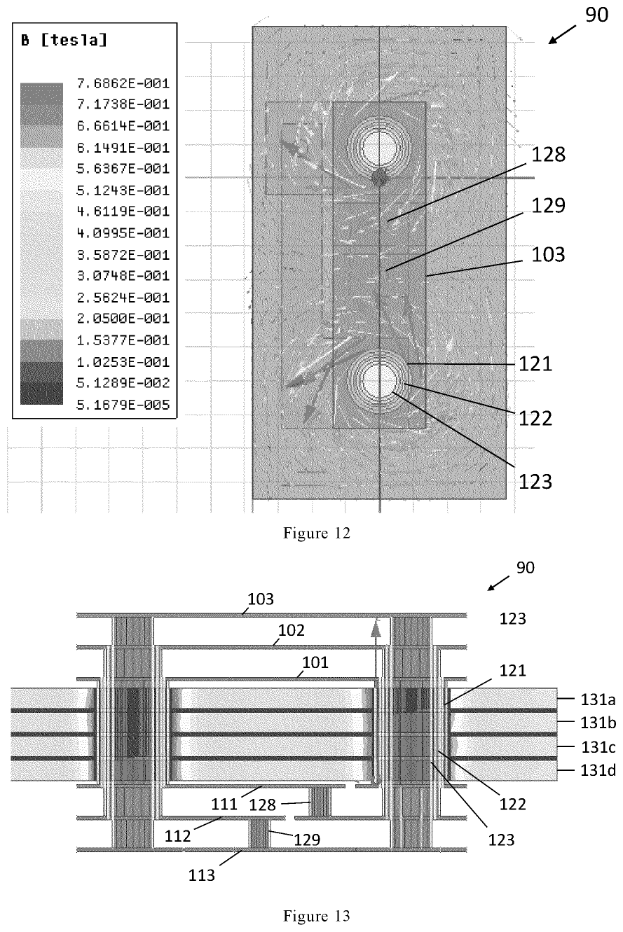

FIGS. 12 to 14 show an example inductor 90, comprising: first, second and third upper conducting layers 101, 102, 103, first second and third conducting layers 111, 112, 113, magnetic core layers 131a-d, and first, second and third concentric through core vias 121, 122, 123. The upper conducting layers 101, 102, 103 are on an upper side of the magnetic core layers 131a-d, and the lower conducting layers 111, 112, 113 are on a lower side of the magnetic core layers 131a-d. The first upper conducting layer 101 is between the second upper conducting layer 102 and the magnetic core layers 131a-d, and the second upper layer 102 is between the third upper conducting layer 103 and the magnetic core layers 131a-d. The first lower conducting layer 111 is between the second lower conducting layer 112 and the magnetic core layers 131a-d, and the second lower layer 112 is between the third lower conducting layer 113 and the magnetic core layers 131a-d.

The first through core via 121 connects the first upper conducting layer 101 to the first lower conducting layer 111. The second through core via 122 connects the second upper conducting layer 102 to the second lower conducting layer 112, and the second through core via 122 is surrounded by the first through core via 121. The third through core via 123 connects the third upper conducting layer 103 to the third lower conducting layer 113, and the third through core via 123 is surrounded by the second through core via 121. Thin insulating layers (as already described) are used to isolate the first, second and third through core vias 121, 122, 123.

The conductor layers 101, 102, 103, 111, 112, 113 and vias 121, 122, 123 together define an inductor winding around the magnetic core, comprising three turns. The first turn comprises the first layers 101, 111, connected by the first through core via 121. A via 128 (between the first and second lower conductive layers 111, 112) connects the first turn to the second turn. The second turn is defined by second layers 102, 112, connected by the second through core via 122. A via 129 (between the second and third lower conductive layers 112, 113) connects the second turn to the third turn. The third turn is defined by the third layers 103, 113, connected by the third through core via 123.

This embodiment includes the features of the first and second aspects. In the depicted embodiment, there is no spacing between the first through core via 121 and the magnetic core layers 131a-d. This is not essential. In certain embodiments according to the second aspect, there may be a minimum design rule spacing between a pattern defining the first through core via 121 and the magnetic core layers 131a-d (e.g. of at least 20 microns, at least 50 microns, or at least 100 microns).

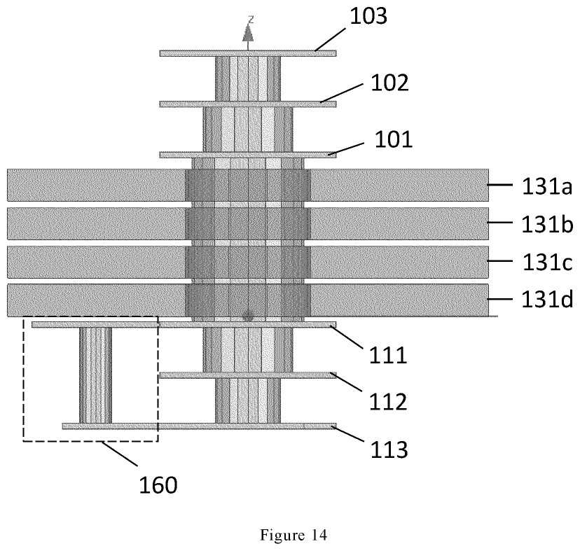

FIGS. 12 and 14 include a connection between the third lower conducting layer 113 and the first lower conducting layer 111, in box 160 (visible in FIG. 12, to the left of the main inductor structure). This is included for simulation purposes to complete the coil, and is not required in a real device, so may be ignored.

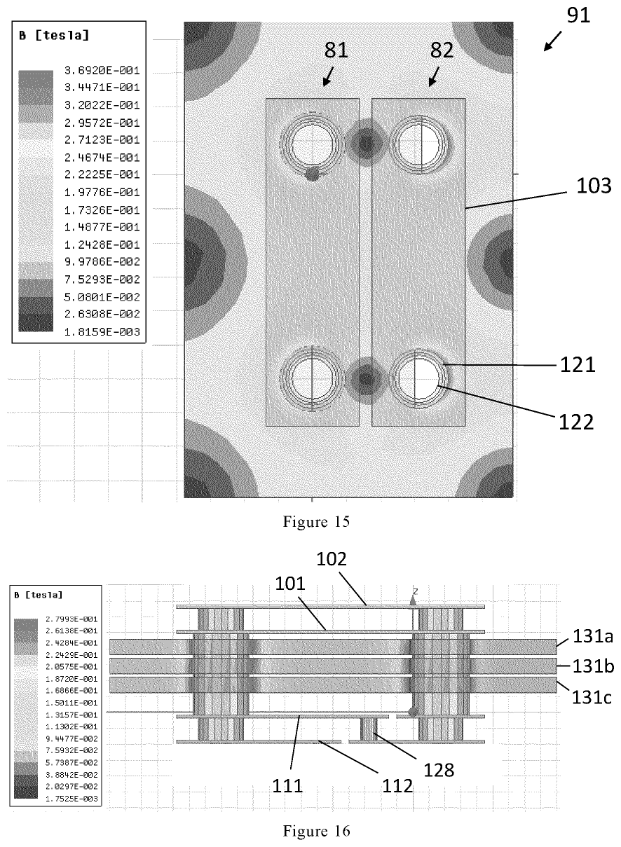

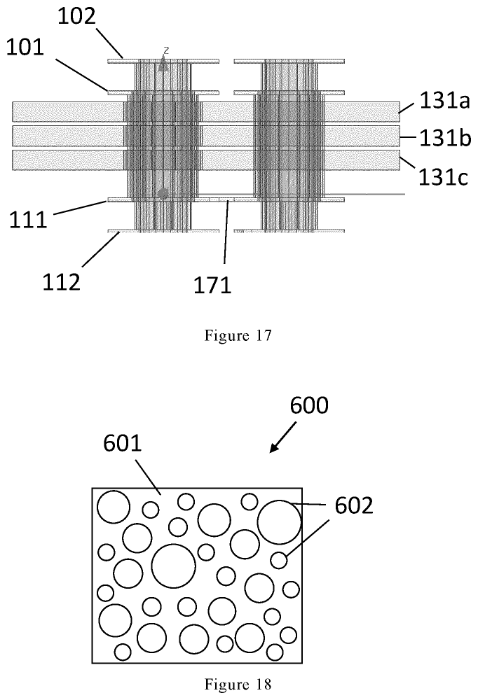

FIGS. 15 to 17 show a four turn inductor 91, comprising a first two turn concentric inductor 81 connected to a second two turn concentric inductor 82. Three magnetic core layers 131a-c are provided in a stacked configuration. There are two conductor layers 101, 102, 111, 112 on either side of the stacked magnetic core layers 131a-c. A via 128 connects an inner turn (defined by first conducting layers 101, 111 and first through core via 121) with an outer turn (defined by second conducting layers 102, 112 and second through core via 122). The first through core 121 via is concentric with (and surrounds) the second through core via 122. A connection 171 is made between the two adjacent inductors 81, 82. In this example, the connection 171 is between the first lower conducting layers, but this is not essential. In this example a current path is provided from the outer turn to the inner turn in the first inductor 81, then from the inner turn of the first inductor to the inner turn of the second inductor 82, then from the inner turn of the second inductor 82 to the outer turn of the second inductor. Other current paths are also possible, depending on how the two inductors are connected.

FIG. 18 shows an example magnetic composite material 600, which is suitable for use as a magnetic core layer. The material 600 comprises magnetic particles 602, which may each be coated in an insulating coating. The magnetic particles 602 are embedded in a binder. The binder may be an insulator, for example a ceramic material bound together by a polymeric material.

The material core layer may be deposited using a range of different methods, for example by sputter deposition, or paste deposition. In some embodiments an entire PCB core may be formed from magnetic material (rather than placing a magnetic layer within a cavity in an existing core layer).

Devices according to embodiments may be used in a range of functions such as: filtering: for energy store and release; and in switch mode power converters. Devices according to embodiments may be used in signal or power transformers, used to achieve functions such as galvanic isolation, voltage or impedance transformation.

Embodiments are applicable to any magnetic device utilizing magnetic material for magnetic flux enhancement.

Certain embodiments comprise a non-isolated point of load DC-DC converter, which is commonly used to generate a well-regulated voltage rail for use by an integrated circuit. The input voltage to the converter might be a battery voltage which might be at a nominal level such as 3.7 V (depending on the electrochemistry used). As the battery discharges, the converter may use closed loop control to maintain an output voltage tightly regulated at a desired level for the “load” circuitry such as 1.8 V. This tight regulation level should be maintained in the presence of input voltage or load variations or disturbances. An example of this type of DC-DC converter/regulator is the MicroSiP™ power module from Texas Instruments. Embodiments may comprise similar regulators with the features described herein.

Although example processes have been described for forming devices in accordance with an embodiment, a range of processes may be used. The steps described by way of example are merely illustrative and not exhaustive. Additional steps may be used, for example to planarize the magnetic core layer (or an adhesive fill holding the magnetic core layer in place).

Although example embodiments have been described in which the magnetic core layer is disposed in a cavity formed in a core layer, this is not essential. In some embodiments the magnetic core layer may be deposited on a core layer (e.g. sputter coated as a thin layer), or on any other substrate layer (e.g. ceramic, silicon etc).

Embodiments have the potential to provide higher density inductors, which may enable future advances in compact electronic or electrical devices.

The scope of the present invention is not intended to be limited by the example embodiments, but should be determined with reference to the accompanying claims.

1. A device, comprising:
a first upper conducting layer and second upper conducting layer;
a first lower conducting layer and second lower conducting layer;
a core layer between the first and second upper conducting layers and the first and second lower conducting layers;
a first via connecting the first upper conducting layer to the first lower conducting layer;
a second via connecting the second upper conducting layer to the second lower conducting layer;
wherein the first via and the second via are concentric.

2. The device of claim 1, wherein the core layer is a magnetic core layer.

3. The device of claim 2, wherein at least one of the first upper conducting layer, second upper conducting layer, first lower conducting layer and second lower conducting layer are patterned to form an inductor winding around an inductor core, the inductor core comprising at least a region of the magnetic core layer.

4. The device of claim 3, wherein the first via and the second via are through core vias that are at least partially surrounded by the magnetic core layer.

5. The device of claim 3, comprising more than two patterned upper conducting layers, and more than two patterned lower conducting layers, each of the more than two patterned upper conducting layers and the more than two patterned lower conducting layers forming the inductor winding.

6. The device of claim 1, wherein:
the core layer is a magnetic core layer; and
i) the first via is in contact with the magnetic core layer; or
ii) the device comprises a conformal insulating layer between the first via and the magnetic core layer.

7. The device of claim 1, wherein the core layer is a magnetic core layer, and the magnetic core layer is one of a plurality of magnetic core layers between the first upper conducting layer and the first lower conducting layer.

8. The device of claim 1, wherein the core layer is a magnetic core layer, and the magnetic core layer is an electrical insulator.

9. The device of claim 1, wherein the core layer is a magnetic core layer, and the magnetic core layer comprises a polymeric matrix with embedded metal particles, or a sputter coated magnetic core layer.

10. The device of claim 1, wherein the device is a printed circuit board.

11. The device of claim 1, wherein the first upper conductive layer, first lower conductive layer and the first via consist of the same material.

12. A method of forming a concentric via, the method comprising:
forming a first through hole through a core layer;
depositing a conducting material in the first through hole to form a first via;
forming a second through hole through the first via and concentric with the first via;
depositing an insulating material on an interior sidewall of the second through hole;
depositing a conducting material in the second through hole to form the second via.

13. The method of claim 12, wherein depositing the insulating material comprises electrodeposition of the insulating material.

14. The method of claim 12, wherein depositing the insulating material comprises vapour depositing the insulating material.

15. The method of claim 12, comprising forming a device comprising:
a first upper conducting layer and second upper conducting layer;
a first lower conducting layer and second lower conducting layer;
a core layer between the first and second upper conducting layers and the first and second lower conducting layers;
a first via connecting the first upper conducting layer to the first lower conducting layer;
a second via connecting the second upper conducting layer to the second lower conducting layer;
wherein the first via and the second via are concentric.
